(19) United States
(12) Patent Application Publication
(10) Pub. No.: US 2022/0306330 A1
(43) Pub. Date: Sep. 29, 2022

(54) PACKAGING SYSTEM AND METHOD WITH FAULT ANALYSIS

(71) Applicant: MULTIVAC SEPP HAGGENMUELLER SE & CO. KG, Wolfertschwenden (DE)

(72) Inventors: Juergen STEIDELE, Hawangen (DE); Martin ROTH, Ofterschwang (DE)

(73) Assignee: MULTIVAC SEPP HAGGENMUELLER SE & CO. KG, Wolfertschwenden (DE)

(21) Appl. No.: 17/707,224

(22) Filed: Mar. 29, 2022

(30) Foreign Application Priority Data
Mar. 29, 2021 (DE) 102021107878.4

(51) Int. Cl. B65B 57/18; B65B 57/12; B65B 57/14; B65B 35/24

(52) U.S. Cl. CPC B65B 57/18; B65B 57/12; B65B 57/14; B65B 35/24

(57) ABSTRACT

In a packaging system including a packaging machine and at least one component provided in addition to the packaging machine, the packaging system includes a display and a computer unit. The system is configured to display a performance graphic on the display. The computer unit includes a fault analysis section that is configured to detect a stop or output deficit of the packaging system and, when a stop or an output deficit is detected, to determine, from a list of error sources stored in a memory, an error source causing the stop or output deficit so that the determined error source is shown on the display.

### CROSS-REFERENCE TO RELATED APPLICATIONS

This application claims foreign priority benefits under 35 U.S.C. § 119(a)-(d) to German patent application number DE 10 2021 107 878.4, filed Mar. 29, 2021, which is hereby incorporated herein by reference in its entirety.

### TECHNICAL FIELD

The disclosure relates to a packaging system, as well as to a method for operating a packaging system.

### BACKGROUND

A packaging system is understood to be a system including at least one packaging machine (i.e., a machine, in which products are packaged in packaging material) and, in addition to the packaging machine, at least one further component. In the context of the disclosure, this further component may be any machine or station that acts on the products and/or on the packaging material in any way. For example, the further component may be a transport device for transporting products, such as a feed conveyor, a conveyor belt, a transfer robot, such as a Delta or Scara robot, or the like. The additional component may also be, for example, a printing device for applying a print to packaging material, an inspection device such as a vision system or a check weigher, or a labeler. The component of the packaging system provided in addition to the packaging machine may also be a filler for filling packages with a product. In addition to the at least one packaging machine, the packaging system may have one or more such additional components.

Packaging systems with a packaging machine and at least one additional component are disclosed, for example, in DE 10 2018 222 397 A1, DE 10 2018 214 761 A1 or DE 10 2017 124 650 A1.

Such packaging systems typically have a rated output, i.e., an output achievable in trouble-free normal operation, i.e., a number of finished packages per unit time (for example, per minute). The actual output of the packaging system may be subject to fluctuations and, in particular, may fluctuate around the rated output. It becomes critical when a shortfall in output occurs. In the context of the disclosure, an “output deficit” may be defined as an output of, for example, 95% or less of the rated output, or 90% or less of the rated output. A special case of an output deficit is a stop of the packaging system, i.e., a reduction of the instantaneous output of the packaging system to zero. A reduction in output or even a stop of the packaging system may have a variety of causes.

### SUMMARY

It is the object of the present disclosure to improve a packaging system and a method for operating a packaging system in such a way that the average performance of the packaging system is increased.

According to the disclosure, the packaging system is configured to show a performance graphic on the display. The performance graphic displays, preferably in real time, a current output of the packaging system, preferably also the history of the actual output achieved over a certain period of time going back into the past. For example, the output could be shown as a percentage of the rated output. For determining the output, for example in the case of intermittently operating packaging machines or packaging systems, the number of cycles in a given period of time may be used, multiplied by the number of packages produced in a format or in a cycle.

According to the disclosure, the computer unit of the packaging system has a fault analysis section that is designed to detect a stop or output deficit of the packaging system. As stated above, an output deficit may be defined, for example, as an output of at most 95% or at most 90% of the rated output of the packaging system. In general, am output deficit may be considered as an actual output below a certain output threshold. A stop of the packaging line leads to an output of zero and thus to an extreme case of an output deficit.

The fault analysis section is adapted to identify, upon detection of a stop or, in general, an output deficit, an error source causative of the stop or output deficit in question from an error source list stored in a memory. The error source list may contain any discrete number of potential error sources. The error source list may be stored in the form of a list, array, table, or the like. Preferably, it may contain the most common error sources that may cause a stop or an output deficit. Identifying the causal error source may be accomplished by taking into account the information as to whether the packaging machine or a particular other component of the packaging system caused the stop or output deficit, for example based on control or sensor signals received therefrom.

Finally, the packaging system is configured to display the determined error source on the display. This allows the operator of the packaging system to immediately identify the error source and the component or machine causing the fault without having to search for it for any length of time. This speeds up the process of correcting the fault and reduces downtime or periods of reduced output of the packaging system, significantly increasing the overall average output of the packaging system. The packaging system may also be configured to generate an evaluation or statistics of output deficit and its causes. This allows the operation of the packaging system to be further optimized, for example by systematically identifying causes of particularly frequent error sources and avoiding these causes by taking countermeasures.

Error sources leading to a stop may be, for example, the complete failure (or lack of power) of a component or of the packaging machine, or the reaching of a foil end (no more material) of a bottom foil or a lidding foil.

Error sources not resulting in a stop, but in a reduced output may be, for example:

(a) pre-warning of end of label web or end of foil before the end is reached;

(b) labeler not active/ready, in case two labelers (redundant system) have to be ready, but only one is in operation for labeling. (The label roll of the other one could be renewed during the waiting time);

(c) waiting for feedback from components (e.g., ready or finished signal is missing); and

(d) evacuation time has been exceeded, the ACTUAL time for evacuation was longer than the TARGET time.

In the context of the disclosure, “messages” from the system or its components should be considered synonymous with “faults” if they refer to reporting an event or condition that has resulted in a stop or reduced output. Accordingly, the stored error source list may also be or include a list of potential messages.

Preferably, the fault analysis section is configured to store a timestamp associated with a detected stop or output deficit of the packaging system. The timestamp may be the time (in hours, minutes, seconds if applicable), plus the date if applicable, of when a stop or output deficit occurred or was detected. The timestamp may also indicate the duration of a stop or output deficit. The term associated in this context means that the time stamp is assigned to a specific stop or a specific output deficit.

It has been found to be advantageous for the handling if the performance graphic includes a representation of an output of the packaging system or the packaging machine over a time axis. In such a two-dimensional representation, the course of the output over a certain period of time may thus be read.

In one embodiment of the packaging system, at least one sensor is connected to the computer unit. The computer may monitor parameters and report them to the computer unit in the form of sensor signals that allow conclusions to be drawn about an output, an output deficit, a stop or about the fault underlying a stop or an output deficit, for example temperatures, electrical currents, electrical voltages, mechanical voltages, pressures, etc. Within the computer unit, the signal received from the sensor may be fed to the fault analysis section.

The packaging system may further be configured to display fault messages and/or warnings on the display. This makes it easier for the operator to detect a malfunction.

In one embodiment, the display may be located on or in the packaging machine. This has the advantage that the operator will frequently be at or near the packaging machine and he may easily see the display here. Alternatively or additionally, however, the display or an additional display may also be located remotely from the packaging machine, for example in an operator room where the display may be connected to the packaging machine and the additional component or components of the packaging system via a data network (wired or wireless) or a cloud connection, or on a mobile terminal.

The same applies to the computer unit or its fault analysis section. Also, the computer unit and/or the fault analysis section may be located on or in the packaging machine or on or in one of the additional components of the packaging system. Alternatively, the computer unit and/or the fault analysis section (or parts thereof) may be located remotely from the packaging machine, for example in a control room or on a mobile terminal, and may be integrated into the packaging system via a wired or wireless data connection.

The disclosure also relates to a method for operating a packaging system, in which a performance graphic is shown on a display of the packaging system, an error source list is stored in a memory, a fault analysis section of a computer unit determines from the error source list an error source that is causal for the relevant stop or output deficit in the event of a stop or output deficit of the packaging system, and the determined error source is finally shown on the display. In this way the advantages are obtained as described at the beginning.

It is useful if the error source list allows to be edited. In particular, error sources may be specified and/or additional error sources may be added to the list in this way. Editing the error source list may preferably be done from the display.

Preferably, the performance graphic includes a representation of an output of the packaging system or the packaging machine over a time axis, again providing the advantages described above.

It is conceivable that the performance graphic is updated continuously or on a cycle-by-cycle basis. If the packaging machine or the packaging system as a whole operates intermittently or cyclically, the cyclic updating of the performance graphic may be synchronized with the operating cycle of the packaging system or machine.

In a further embodiment, it is conceivable that recipe changes and/or parameter changes are shown on the display in or together with the performance graphic. This increases the scope of information provided to the operator and may further facilitate the location of a fault.

It is further conceivable that a time of occurrence of a stop or an output deficit is recorded and stored, ideally in association with a particular stop or output deficit. Additionally or alternatively, it is conceivable that a time period or duration of a stop or output deficit is recorded and stored, again ideally in association with a particular stop or output deficit.

The packaging machine may be, for example, a tray sealer or a thermoforming packaging machine. It would also be conceivable for the packaging machine to be of the chamber machine or chamber belt machine type.

### BRIEF DESCRIPTION OF THE DRAWINGS

In the following, advantageous embodiments of the disclosure are explained in more detail with reference to a drawing. In particular in the figures:

FIG. 1 shows an embodiment of a packaging system with a tray sealing machine;

FIG. 2 shows a second embodiment of a packaging system with a thermoforming packaging machine;

FIG. 3 shows a schematic representation of the packaging line; and

FIG. 4 shows an embodiment of a performance graphic.

Throughout the figures identical components are indicated with the same or corresponding reference signs.

### DETAILED DESCRIPTION

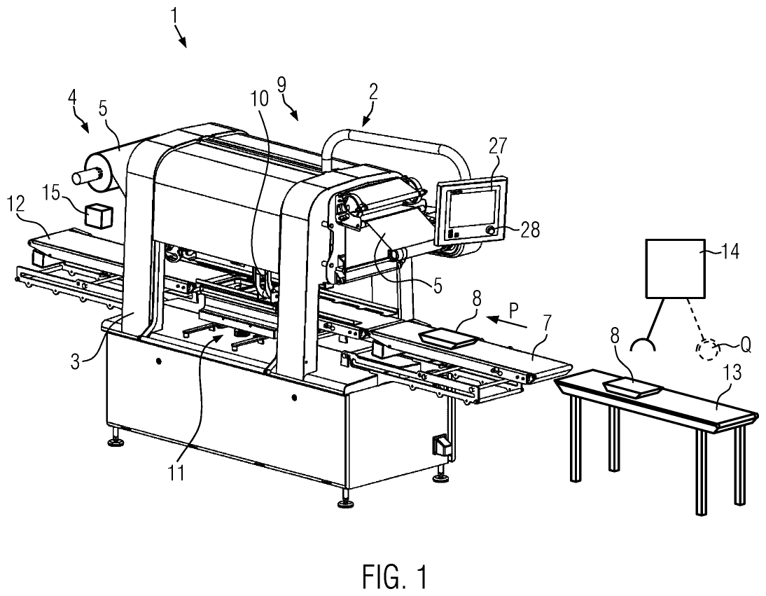

FIG. 1 shows a first embodiment of a packaging system 1. The packaging system 1 includes a packaging machine 2, which in the present embodiment is a tray sealing machine (tray sealer). The packaging machine 2 includes a frame 3 that may support a supply roll 4 of a lidding foil 5. The packaging machine 1 further includes a feed belt 7, by means of which filled but at this point still unsealed trays 8 may be fed to a sealing station 9 of the packaging machine 2. The trays 8 may be transferred to the sealing station 9 by means of a gripper device 10 in a production direction P and may be sealed there with the lidding foil 5 (foil) supplied from above, for example by sealing the lidding foil 5 to the trays 8. For this purpose, the sealing station 9 may include a sealing tool 11. The sealed and thus completed packages may be transferred from the sealing station 9 to a discharge conveyor 12 via the gripper device 10.

In addition to the packaging machine 2, the packaging system 1 has one or more further components, in the present example a conveyor belt 13, a filler 14 and an inspection device 15. The conveyor belt 13 is used for conveying unsealed trays 8 during them being filled with a product Q. The conveyor belt 13 is used for conveying unsealed trays 8 during them being filled. A filler 14 in the vicinity of the conveyor belt 13 serves to pick up the products Q and transfer them into the trays 8. For this purpose, the filling device 14 may be configured, for example, as a suction gripper, as a transfer robot or as a (possibly intermittently operating) pouring device. Downstream of the sealing station 9 in the transport direction P there is arranged an inspection device 15, for example a vision system, a metal detector or a check weigher. The inspection device 15 is used to determine properties of the finished packages or the products packaged therein.

A display 27 is arranged on the packaging machine 2. The display has operating elements 28.

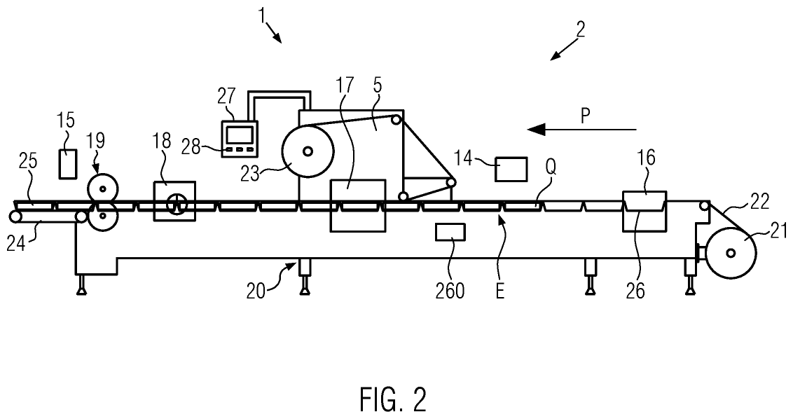

FIG. 2 shows a second embodiment of a packaging system 1, this time with a packaging machine 2 in the form of a thermoforming packaging machine. The thermoform packaging machine 2 has a forming station 16, a sealing station 17, a cross-cutting device in the form of a foil die-cutter 18 and a longitudinal cutting device 19, which are arranged in this order in a production direction P on a machine frame 20. On the input side, a feed roller 21 is located on the machine frame 20, from which a foil web 22 is drawn off. In the area of the sealing station 17, a web accumulator 23 is provided, from which a lidding foil 5 is drawn off. On the output side, a discharge device 24 in the form of a conveyor belt is provided on the thermoforming packaging machine 2, with which finished separated packages 25 are transported away. Furthermore, the thermoforming packaging machine 2 has a feed device, which grips the foil web 22 and transports it further in the production direction P per main working cycle. The feed device may be designed, for example, by means of clamp chains arranged on both sides.

In the embodiment shown, the forming station 16 is designed as a deep-drawing station, in which troughs 26 are formed in the foil web 22 by deep-drawing. The forming station 16 may be designed in such a way that several troughs 26 are formed next to each other in the direction perpendicular to the production direction P. The troughs 26 are formed by deep-drawing. An insertion section E is provided downstream of the forming station 16 in the production direction P, in which the troughs 26 formed in the foil web 16 are filled with products Q by means of a filler 14 provided in addition to the packaging machine 2.

The cross-cutting device 18 is designed as a foil die-cutter, which cuts through the foil web 22 and the lidding foil 5 in a direction transverse to the production direction P between adjacent troughs 26. The foil die-cutter 18 operates in such a way that the foil web 22 is not cut across its entire width, but is not cut through at least in an edge region. This enables controlled further transport through the feed device.

In the embodiment shown, the longitudinal cutting device 19 is designed as a knife arrangement with a plurality of rotating circular knives, with which the foil web 22 and the lidding foil 5 are cut through between adjacent troughs 26 and at the lateral edge of the foil web 22, so that separated packages 25 are present downstream of the longitudinal cutting device 19.

The thermoforming packaging machine 2 further includes a control unit 260, which has the task of controlling and monitoring the processes taking place in the thermoforming packaging machine 2. A display 27 arranged here on the thermoforming packaging machine 2 with operating elements 28 serves to visualize for or manipulate by an operator the process sequences in the thermoforming packaging machine 2.

In addition to the packaging machine 2, the packaging system 1 may also include an inspection device 15 in addition to the filler, and optionally other additional components.

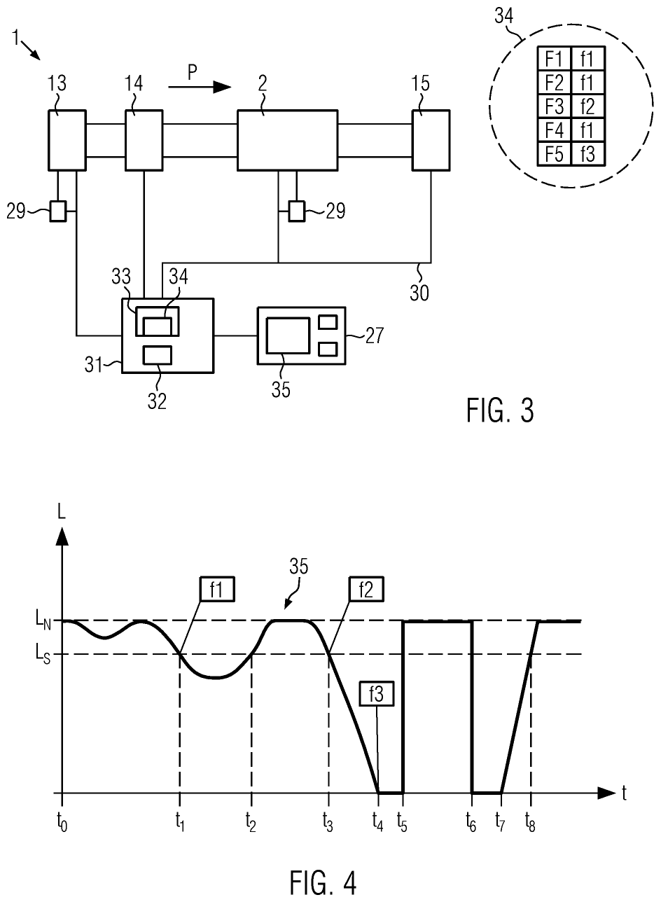

FIG. 3 again schematically shows the packaging system 1 with the packaging machine 2 and components 13, 14, 15 provided in addition to the packaging machine 2. It is indicated in a schematic manner that a sensor 29 is provided on or in the packaging machine 2 as well as on or in the conveyor belt 13 in each case, by means of which at least one parameter of the associated machine 2 or component is monitored.

The packaging machine 2 as well as the additional components 13, 14, 15 and the sensors 29 are connected to a computer unit 31 via data and control lines 30. The computer unit may be a control computer for the packaging system 1. The computer unit has a fault analysis section 32 and a memory 33 that stores an error source list 34. The error source list 34, also shown in an enlargement, may include a number of different faults F1, F2, F3, . . . , each fault F1, F2, F3 being associated with a particular or a most probable error source f1, f2, f3, It is quite conceivable that different faults F1, F2, F4 are assigned to the same error source f1. An error source f1, f2, f3 may be a specific component 2, 13, 14, 15 of the packaging system 1 or it may be a specific fault within such a component.

A performance graphic 35, which is shown in enlarged form in FIG. 4, may be displayed on the display 27 of the packaging system 1 connected to the computer unit 31. The performance graphic 35 represents an output of the packaging system 1 over a certain period of time, specifically as an output L (packages per unit time) over a time axis t. As explained at the outset, the packaging system 1 has a rated output LN that it may or should achieve during trouble-free normal operation. Depending on various factors, the actual output L(t) achieved may fluctuate, as shown in FIG. 4.

An output L below a certain output threshold LS is taken to be an output deficit. The fault analysis section 32 of the packaging system 1 is designed to detect when an output deficit occurs.

In the example according to FIG. 4, the packaging system 1 starts at its nominal output at time t0. At time t1, the output L falls below the output threshold LS for the first time. Up to time t2, there is an output deficit of the packaging system 1, and only then does the output L rise above the output threshold LS again.

At time t3, the output of the packaging system 1 again falls below the output threshold LS until a complete stop at time t4. Only at time t5 does the packaging system 1 operate again at its rated output LN. At time t6 an abrupt stop occurs, i.e., the output L is reduced to zero. At time t7, the packaging system 1 starts to operate again; at time t8, the output threshold LS is exceeded.

An output deficit, i.e., an output L below the threshold LS, thus occurs between the times t1 and t2, between the times t3 and t5, and between the times t6 and t8. A stop of the packaging system 1 occurs between times t4 and t5, and between times t6 and t7.

As soon as the fault analysis section 32 has identified a (most probable) reason for the occurrence of a particular stop or output deficit, i.e., the error source f1, f2, f3 causing it, the identified error source f1, f2, f3 is indicated on the display 27, preferably within the performance graphic 35. FIG. 4 shows an example of how this may be accomplished. Each time of the occurrence of an output deficit or a stop t1, t3, t4 is associated with a display of the error source f1, f2, f3 recognized as causal therefor, as indicated in FIG. 4. For clarity, a determined error source for the occurrence of the stop at time t6 has been omitted. Within the memory 33, each stop or output deficit determined by the fault analysis section 32 may be stored together with an associated timestamp t1, t3, t4, t6. Additionally or alternatively, it is possible to record and store the time duration of each stop or output deficit.

It is noted that the machine 2, conveyor belt 13, filler 14, inspection device 15, display 27, sensors 29, computer unit 31, including fault analysis section 32, control unit 260, and/or any other computer, system, unit, controller, machine, terminal, device, module, arrangement, feature, element, function, functionality, step, algorithm, operation, or the like described herein may comprise and/or be implemented in or by one or more appropriately programmed processors (e.g., one or more microprocessors including central processing units (CPU)) and associated memory (e.g., memory 33) and/or storage, which may include data, firmware, operating system software, application software and/or any other suitable program, code or instructions executable by the processor(s) for controlling operation thereof and/or for performing the particular algorithms represented by the various functions and/or operations described herein, including interaction between, control of, and/or cooperation with each other or any other components, machines, or devices. One or more of such processors, as well as other circuitry and/or hardware, may be included in a single ASIC (Application-Specific Integrated Circuitry) or individually packaged or assembled into a SoC (System-on-a-Chip). As well, several processors and various circuitry and/or hardware may be distributed among several separate components, machines, devices, and/or locations, such as a mobile unit, mobile computing device, mobile terminal, or a remote server.

The packaging system according to the disclosure or the process according to the disclosure may be modified in many ways. It is conceivable that the performance graphic could be updated continuously or on a cycle-by-cycle basis. It is possible for the operator to use a zoom function to enlarge presentation of certain periods of time, or to display larger periods of time, i.e., to change the scale of the time axis t. There is also the possibility for a statistical evaluation of the determined faults and error sources as well as for an editing of the error source list 34, for example via the display 27 or from external devices.

What is claimed is:

1. A packaging system comprising a packaging machine, a display, and a computer unit, wherein
the packaging system is configured to display a performance graphic on the display;
the computer unit comprises a fault analysis section configured to detect a stop or an output deficit of the packaging system and, when a stop or an output deficit is detected, to determine, from an error source list stored in a memory, an error source being the cause of the stop or the output deficit; and
the packaging system is further configured to indicate the determined error source on the display.

2. The packaging system according to claim 1, wherein the fault analysis section is configured to store a time stamp in association with a detected stop or a detected output deficit of the packaging system.

3. The packaging system according to claim 1, wherein the performance graphic comprises a representation of an output of the packaging system or the packaging machine over a time axis.

4. The packaging system according to claim 1, wherein at least one sensor is connected to the computer unit.

5. The packaging system according to claim 1, wherein the packaging system is configured to display fault messages and/or warnings on the display.

6. The packaging system according to claim 1, wherein the display is arranged on or in the packaging machine.

7. A method for operating a packaging system comprising a packaging machine, a display, and a computer unit including a fault analysis section, the method comprising:
displaying a performance graphic on the display;
storing an error source list in a memory;
in the event of a stop or an output deficit of the packaging system, the fault analysis section identifying from the error source list an error source causing the stop or output deficit; and
indicating the determined error source on the display.

8. The method according to claim 7, wherein the error source list is editable.

9. The method according to claim 7, wherein the performance graphic comprises a representation of an output of the packaging system or the packaging machine over a time axis.

10. The method according to claim 7, wherein the performance graphic is updated in at least one of a continuous manner and a cyclical manner.

11. The method according to claim 7, wherein at least one of recipe changes and parameter changes are displayed in or together with the performance graphic.

12. The method according to claim 7 further comprising recording and storing at least one of (i) a time of occurrence of one of a stop and an output deficit, and (ii) one of a period and a duration of one of a stop and an output deficit.

13. A fault identification system for a packaging system comprising a packaging machine, the fault identification system comprising:
a computer unit configured to detect a stop or an output deficit of the packaging system and, when a stop or an output deficit is detected, to determine, from an error source list stored in a memory, an error source being the cause of the stop or the output deficit; and
a display configured to display a performance graphic associated with the packaging system;
wherein the computer unit is further configured to indicate the determined error source on the display.

14. The fault identification system according to claim 13, wherein the computer unit is configured to store a time stamp in association with a detected stop or a detected output deficit of the packaging system.

15. The fault identification system according to claim 13, wherein the performance graphic comprises a representation of an output of the packaging system or the packaging machine over a time axis.

16. The fault identification system according to claim 13, wherein at least one sensor is connected to the computer unit.

17. The fault identification system according to claim 13, wherein the computer unit is configured to indicate a fault message and/or warning on the display.

18. The fault identification system according to claim 13, wherein the packaging system further comprises an additional component, and wherein the additional component comprises a conveyor belt, a filler, or an inspection device.

19. The packaging system according to claim 1, wherein the packaging system comprises an additional component, and wherein the additional component comprises a conveyor belt, a filler, or an inspection device.

20. The method according to claim 7, wherein the packaging system comprises an additional component, and wherein the additional component comprises a conveyor belt, a filler, or an inspection device.
